(19) United States
(12) Patent Application Publication
(10) Pub. No.: US 2004/0204227 A1
(43) Pub. Date: Oct. 14, 2004

(54) Gaming machine with variable trigger

(76) Inventor: Stephen Johnson, Rosebery (AU)

Correspondence Address: MORRISON & FOERSTER LLP, 755 PAGE MILL RD, PALO ALTO, CA, 94304-1018, US

(21) Appl. No.: 10/646,031

(22) Filed: Aug. 22, 2003

(30) Foreign Application Priority Data
Aug. 23, 2002 (AU) 2002950966

(51) Int. Cl. G07F 17/34

(52) U.S. Cl. 463/20

(57) ABSTRACT

A gaming machine has a display and a game controller arrange to control images of symbols displayed on the display. The game controller is arranged to play a game wherein, if a predetermined special symbol outcome, comprising a plurality of special symbols, occurs in a base game, a player is afforded an opportunity of selecting one of those symbols. If, as result of that selection, a predetermined selection outcome occurs, a bonus feature is awarded.

### CROSS-REFERENCE TO RELATED APPLICATIONS

This application claims priority to Australian Patent Application No. 2002950966, filed Aug. 23, 2002, the entirety of which is incorporated by reference.

### FIELD OF THE INVENTION

This invention related to a gaming machine. More particularly, the invention relates to a gaming machine and to an improvement to a game played on such a gaming machine.

### BACKGROUND OF THE INVENTION

Players who regularly play gaming machines quickly tire of particular games and therefore it is necessary for manufacturers of these machines to develop innovative game features which add interest to the games. In so doing, it is hoped to keep players amused and therefore willing to continue playing the game as well as to attract new players.

Also, with the growth that has occurred in the gaming machine market, there is intense competition between manufacturers to supply various existing and new venues. When selecting a supplier of gaming machines, the operator of a venue will often pay close attention to the popularity of various games with their patrons. Therefore, gaming machine manufacturers are keen to devise games and/or game features which are popular with the players as a mechanism for improving sales, retaining customers and attracting new customers.

### SUMMARY OF THE INVENTION

According to a first aspect of the invention, there is provided a gaming machine having a display means and a game control means arranged to control images of symbols displayed on the display means, the game control means being arranged to play a game wherein, if a predetermined special symbol outcome, comprising a plurality of special symbols, occurs in a base game, a player is afforded an opportunity of selecting one of those special symbols and if, as a result of that selection, a predetermined selection outcome occurs, a bonus feature is awarded.

The predetermined special symbol outcome may be the occurrence of a predetermined, minimum number of the special symbols in the base game.

The predetermined selection outcome may be the occurrence of a trigger symbol. The probability of the predetermined selection outcome occurring is related to the number of special symbols which occurred in the base game. More particularly, the probability of the predetermined selection outcome occurring may be directly related to the number of special symbols occurring. In other words, the more special symbols that occur, the higher the probability of the trigger symbol outcome occurring.

At least three special symbols may need to occur for the player to be afforded the opportunity of selecting one. If the minimum number of special symbols occurs, the probability may be less than 50% that the animation into the trigger symbol outcome will occur. If the maximum number of special symbols there may be a 100% probability that the animation into the trigger symbol outcome will occur. For any intermediate number of special symbols occurring, the probability that the animation into the trigger symbol outcome will occur may lie between 50% and 100%. For example, in the case of a five reel spinning reel base, game, when three scatter symbols occur, there may be a 1:3 probability of that outcome occurring. Where four scatter symbols occur, there may be a 1:2 probability of that outcome occurring. For five scatter symbols occurring, there may be a 100% probability of the outcome occurring.

If the predetermined selection outcome occurs, the selected special symbol may animate to change into the trigger symbol. The trigger symbol may include a device and a background scene. If desired, the remaining special symbols may also animate to change into an image of the background scene only. The device of the trigger symbol may move from its starting position across the display means and when the device reaches a side of the display means, a screen display changes to an initial screen display of the bonus feature.

The initial screen display of the bonus feature may give the player a choice of bonus features to be played. At least certain of the bonus features may be second screen features.

The base game may, for example, be a spinning reel game. The reel strips of the base game may carry a set of standard symbols. Further, each reel strip may carry at least one special symbol. The special symbol may be a scatter symbol so that, when the predetermined, minimum number of scatter symbols are spun up, whether on a bought payline or not, the player is afforded the opportunity of selecting one of the scatter symbols.

The gaming machine may include a selecting means for enabling the player to select one of the special symbols. Conveniently, the selecting means may be implemented by a touch sensitive screen on the display means. It will, however, be appreciated that the selecting means could be in the form of one or more selector switches on the gaming machine. The switches may be provided in addition to, or instead, of the touch sensitive screen.

According to a second aspect of the invention, there is provided a game to be played on a game playing apparatus, the game playing apparatus having a display means and a game control means arranged to control images displayed on the display means, wherein, if a predetermined special symbol outcome, comprising a plurality of special symbols, occurs in a base game, a player is afforded an opportunity of selecting one of those special symbols and if, as a result of that selection, a predetermined selection outcome occurs, a bonus feature is awarded.

A game playing apparatus includes one which does not require the wagering of a stake in order to play the game and further includes apparatus which is connectable to a network.

### BRIEF DESCRIPTION OF THE DRAWINGS

The invention is now described by way of example with reference to the accompanying diagrammatic drawings in which:

FIG. 1 shows a perspective view of a gaming machine, in accordance with an embodiment of the invention;

FIG. 2 shows a block diagram of a control circuit of the gaming machine:

FIG. 3 shows a screen display of a base game of a game played on the gaming machine of FIG. 1:

FIGS. 4a and 4b show screen displays of an animation sequence after a player has selected a special symbol occurring in the base game:

FIG. 5 shows a screen display on an initial screen of a bonus feature of the game;

FIG. 6 shows a flow chart of one embodiment of the game played on the gaming machine of FIG. 1; and

FIG. 7 shows a flow chart of another embodiment of the game played on the gaming machine of FIG. 1.

### DETAILED DESCRIPTION OF THE DRAWINGS

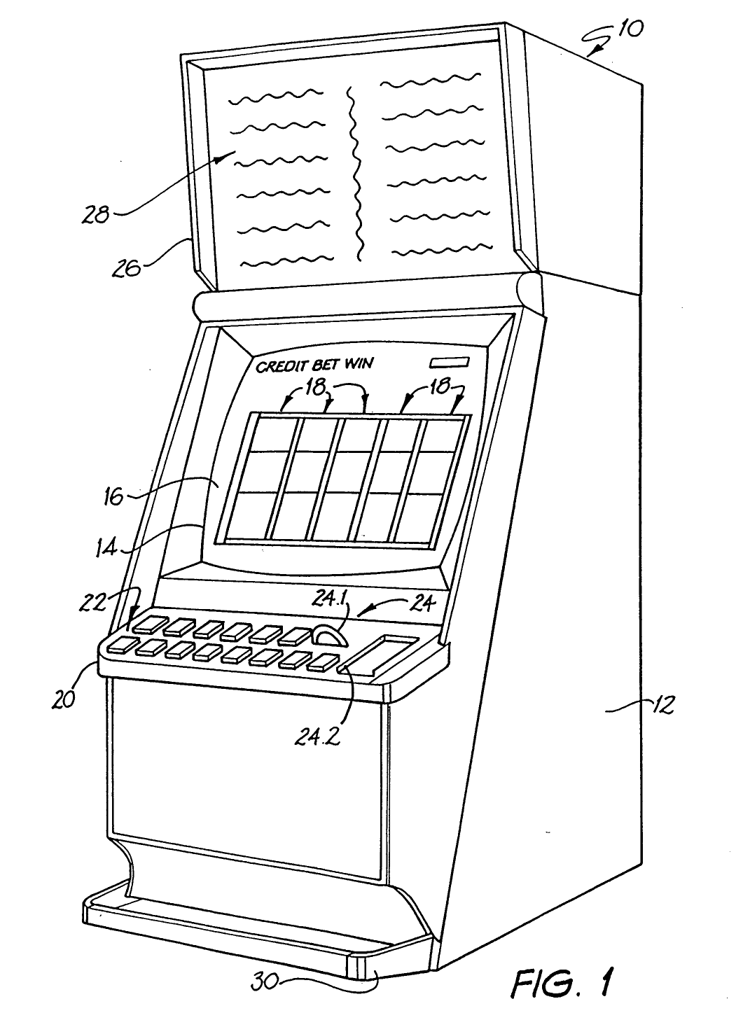

In FIG. 1, reference numeral 10 generally designates a gaming machine, including a game, in accordance with an embodiment of the invention. The machine 10 includes a console 12 having a video display unit 14 on which a game 16 is played, in use. The game 16 is a spinning reel game which simulates the rotation of a number of spinning reels 18. A midtrim 20 of the machine 10 houses a keypad 22 of buttons for enabling a player to play the game 16. The midtrim 20 also houses a credit input mechanism 24 including a coin input chute 24.1 and a bill collector 24.2.

The machine 10 includes a top box 26 on which artwork 28 is carried. The artwork 28 includes paytables, details of bonus awards, etc.

A coin tray 30 is mounted beneath the console 12 for cash payouts from the machine 10.

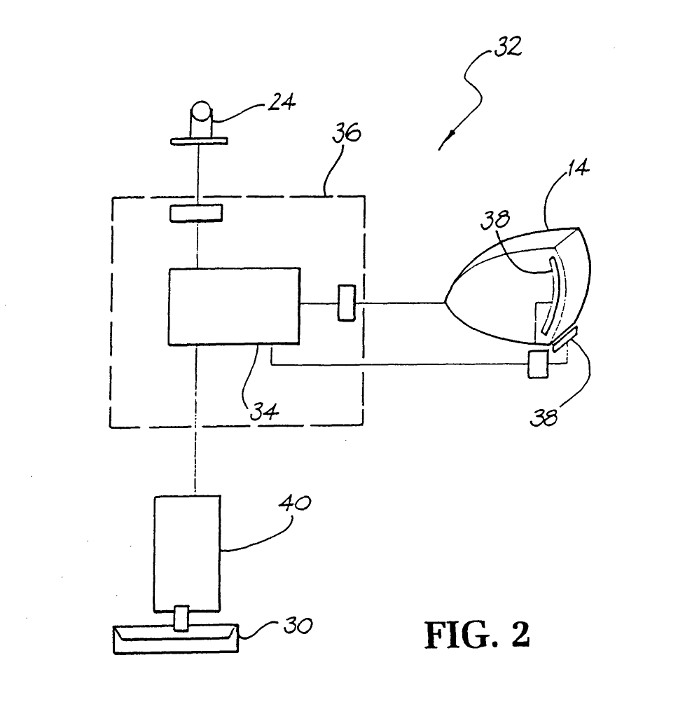

Referring now to FIG. 2 of the drawings, a control means or control circuit 32 is illustrated. A program which implements the game and user interface is run on a processor 34 of the control circuit 32. The processor 34 forms part of a controller 36 that drives the screen of the video display unit 14 and that received input signals from the sensors 38. The sensors 38 include sensors associated with the keypad 22 and touch sensors mounted in the screen of the video display unit 14. The controller 36 also receives input pulses from the mechanism 24 to determine whether or not a player has provided sufficient credit to commence playing. The mechanism 24 may, instead of the coin input chute 24.1 or the bill collector 24.2, or in addition thereto, be a credit card reader (not shown) or any other type of validation device.

Finally, the controller 36 drives a payout mechanism 40 which, for example, may be a coin hopper for feeding coins to the coin tray 30 to make a pay out to a player when a player wishes to redeem his or her credit.

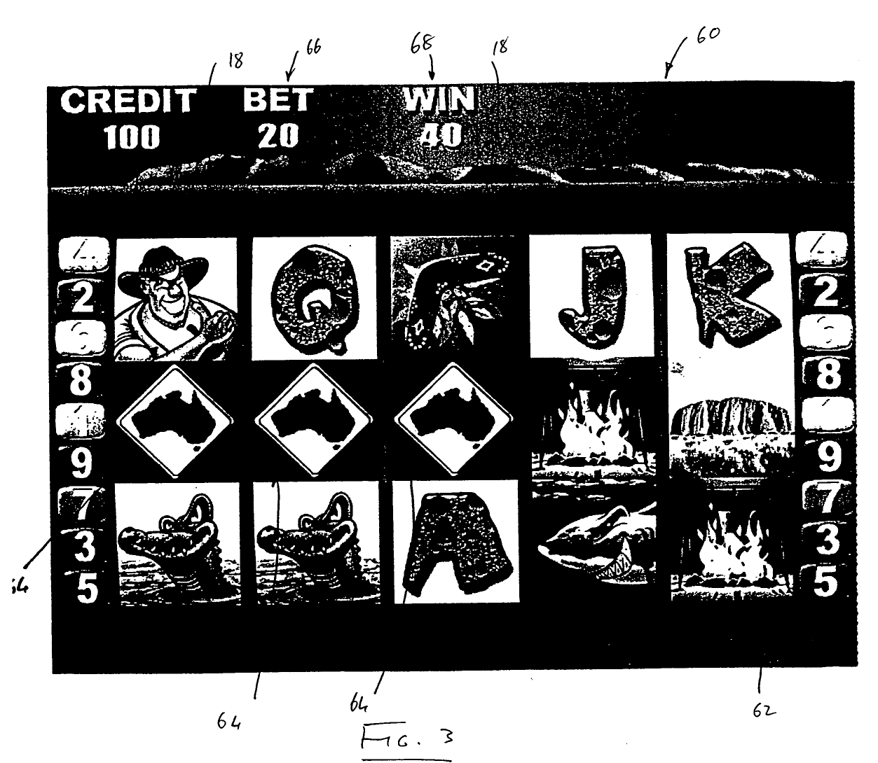

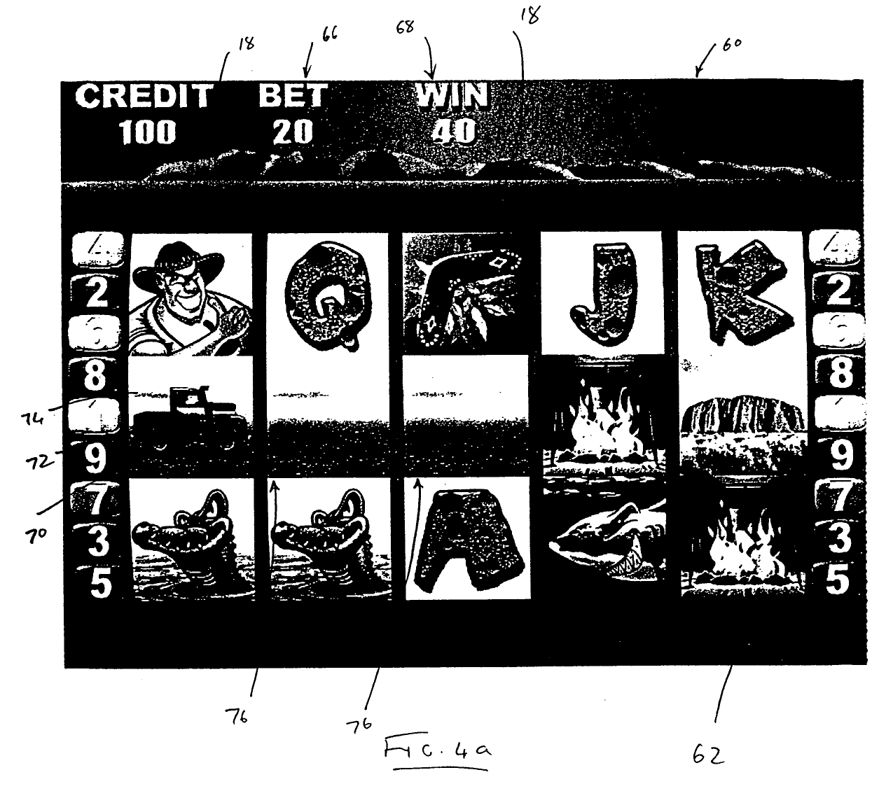

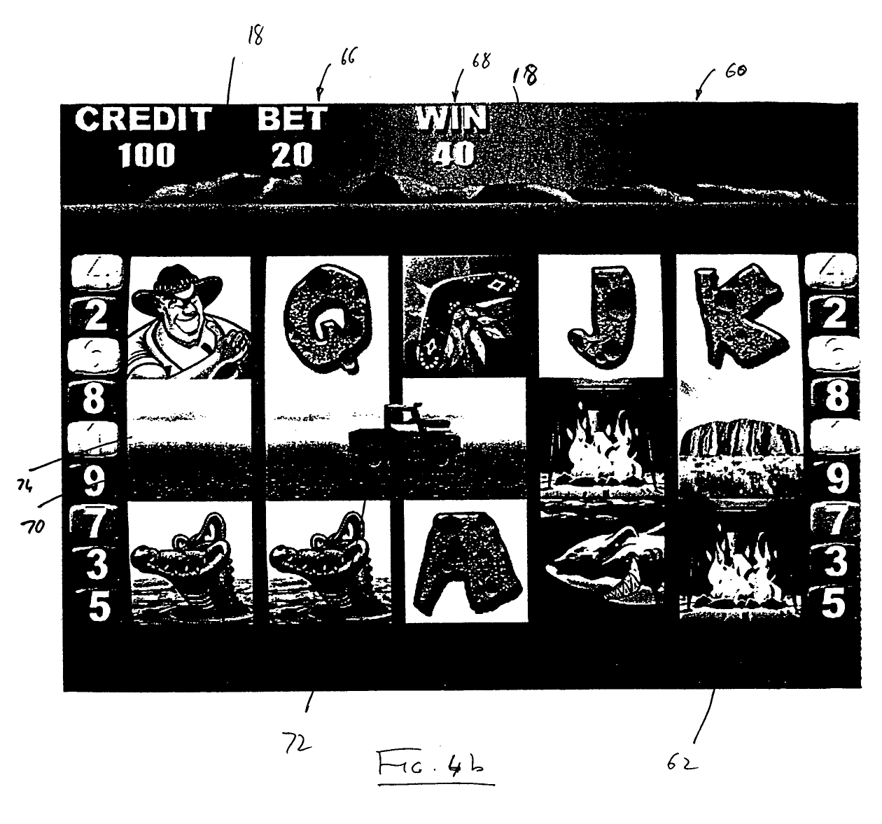

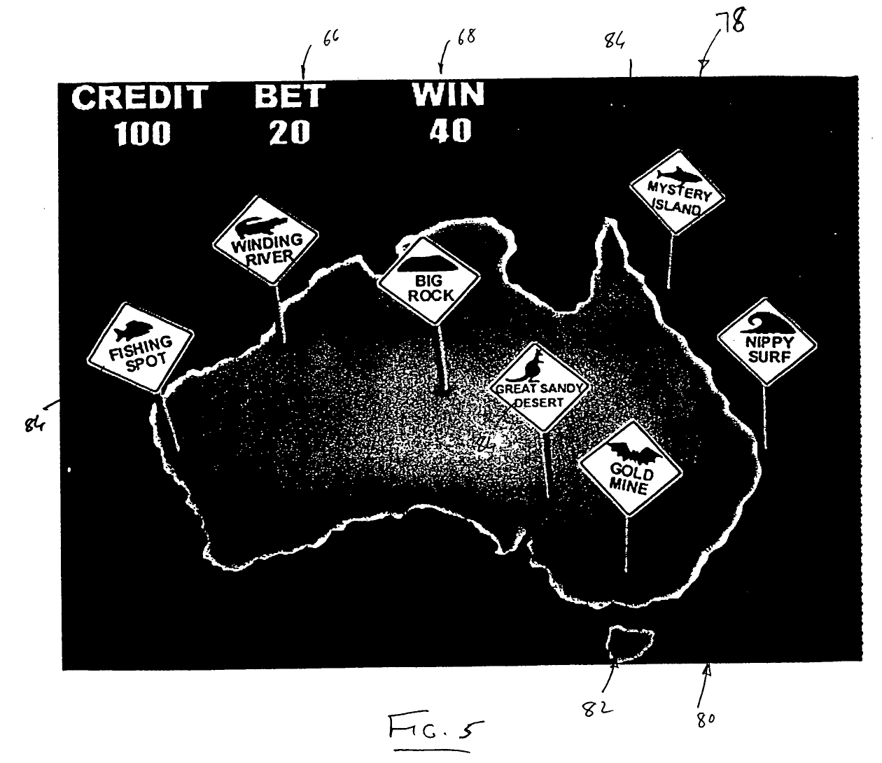

In FIG. 3 of the drawings, reference numeral 60 designates a screen display of a base game 62 of the game 16 played on the gaming machine 10. The base game 62 is a spinning reel game. The spinning reel game 62 has a plurality of spinning reels 18. Each reel 18 has at least one special symbol in the form of a scatter symbol 64. When three or more scatter symbols appear, the player has a chance to win a bonus feature.

In the embodiment shown, the scatter symbol is in the form of a “Map” symbol. As indicated, three of the Map symbols 64 are spun up in the base game 62 as illustrated in FIG. 3 of the drawings.

A prize is awarded for the occurrence of the three Map symbols 64. In this case, the prize is twice the total credits bet. As indicated on a bet meter 66, 20 credits were initially bet by a player. As a result, a prize of 40 credits is credited to a win meter 68 on the screen display 60.

When three or more Map symbols 64 appear, a message (not shown) is displayed to the player advising the player to select one of the Map symbols 64. The Map symbol 64 is selected by the player by toughing the symbol 64. Due to a touch sensitive screen on the video display unit 14 of the gaming machine 10, the controller 36 determines which of the Map symbols 64 has been selected.

The selected Map symbol 64 animates and, if a correct choice of Map symbol 64 has been made, as determined by the controller 36, the selected Map symbol 64 animates into a trigger symbol 70. It is to be noted that the trigger symbol 70 has a device in the form of a vehicle 72 superimposed on a background image 74.

The probability of the trigger symbol 70 being revealed when one of the Map symbols 64 is selected is directly proportional to the number of Map symbols 64 which occurred in the base game 62. More particularly, if there Map symbols 64 are spun up in the base game 62, there is a 1:3 probability of the trigger symbol 70 being revealed by the animation. If four Map symbols are spun up in the base game 62, there is a 1:2 chance of the trigger symbol 70 being revealed. If five Map symbols 64 appear, there is a 100% probability of the trigger symbol 70 being revealed.

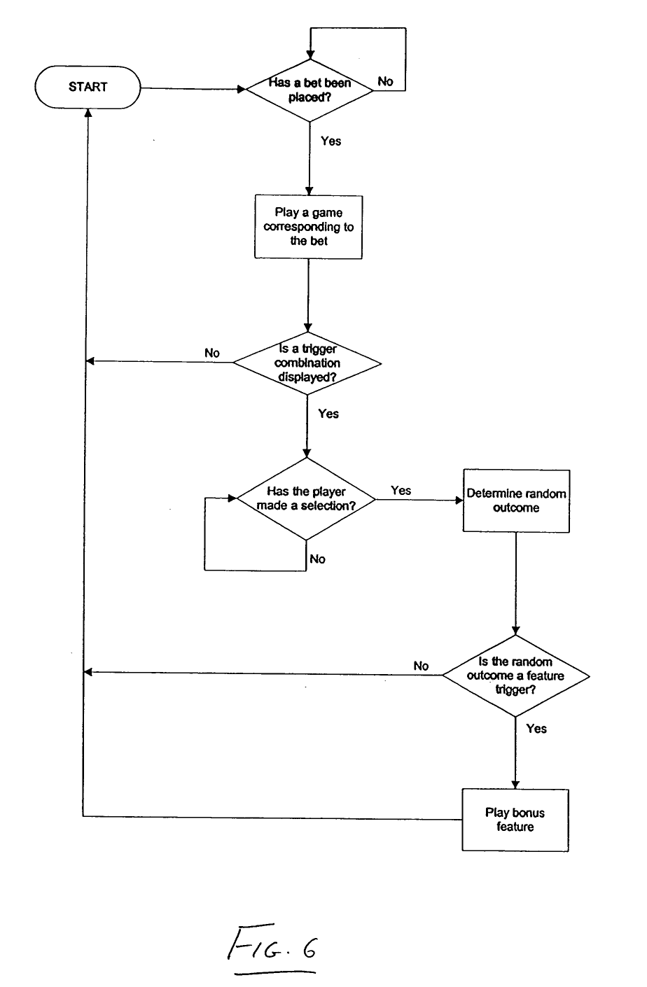

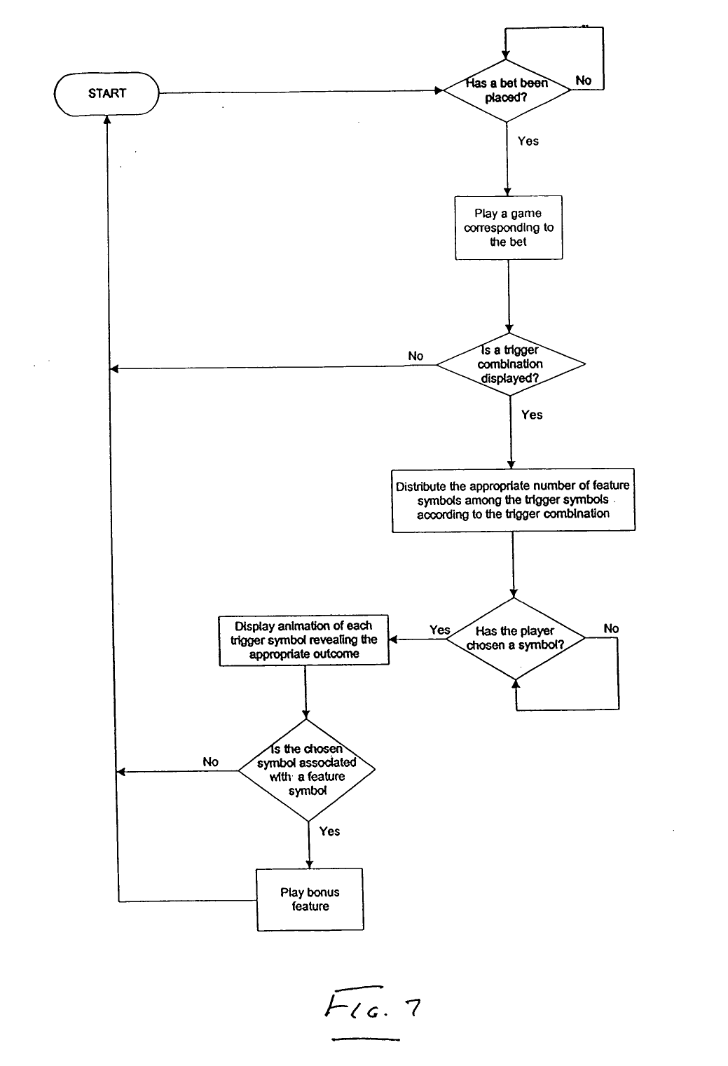

A random determination based on the probability of the feature being triggered may be made by the controller 36 immediately after the player selected the Map symbol 64 as shown in the flow chart of FIG. 6 in the drawings. Then, the only animation that will occur will be of the symbol 64 chosen by the player to reveal whether or not the bonus feature has been awarded. Instead, and preferably, the trigger symbols 70 are distributed among the Map symbols 64 of the trigger combination prior to the player selecting one of the Map symbols 64 of the trigger combination prior to the player selecting one of the Map symbols 64 so that an animation of all the Map symbols 64 occurs, as shown in the flow chart of FIG. 7 of the drawings, and as described in greater detail below.

In the latter case, whenever one of the Map symbols 64 are selected, all the Map symbols 64 animate. In the case of the non-selected, remaining Map symbols 64, they animate into symbols 76 having only the background image 74 without the vehicle device 72. Should the player have chosen the incorrect Map symbol 64, then that Map symbol 64 would animate into the symbol 76 and the game 16 would be over.

If the player has selected the correct Map symbol 64, it animates into the trigger symbol 70 having the background image 74 on which the vehicle device 72 is superimposed.

The vehicle 72 than animates to “drive” across the screen display 60 towards a right hand side of the screen display 60. When the vehicle device 72 reaches the right hand side of the screen display 60, the screen display 60 changes into an initial screen display 78 of a second screen feature 80. In the illustrated embodiment, the screen display 78 is a representation of a map 82 of Australia. Various “signposts” symbols 84 are displayed about the map 82, each symbol 84 being associated with a bonus feature. These symbols 84 are arranged below a touch sensitive part of the screen of the video display unit 14 of the gaming 10. The player selects one of the bonus features of the second screen feature by selecting one of the symbols 84. The player selects the symbol 84 by touching it. Once the appropriate symbol 84 has been touched by the player, the initial screen display 78 is replaced by a screen display (not shown) of the selected bonus feature of the second screen feature 80.

It is an advantage of the invention that a means is provided whereby the suspense in triggering a bonus feature is increased and the manner in which the bonus feature is awarded is entertaining. It is believed that this will heighten the enjoyment of the game by the player encouraging more frequent playing of the game.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

I claim:

1. A gaming machine comprising a display and a game controller configured to control images of symbols displayed on the display, the game controller being configured to play a game wherein, if a predetermined special symbol outcome, comprising a plurality of special symbols, occurs in a base game, a player is afforded an opportunity of selecting one of those special symbols and if, as a result of that selection, a predetermined selection outcome occurs, a bonus feature is awarded.

2. The gaming machine of claim 1 in which the predetermined special symbol outcome is the occurrence of a predetermined, minimum number of the special symbols in the base game.

3. The gaming machine of claim 1 in which the predetermined selection outcome is the occurrence of a trigger symbol.

4. The gaming machine of claim 3 in which the probability of the predetermined selection outcome occurring is related to the number of special symbols which occurred in the base game.

5. The gaming machine of claim 3 in which, if the predetermined selection outcome occurs, the selected special symbol changes into the trigger symbol.

6. The gaming machine of claim 5 in which the trigger symbol includes a device and a background scene.

7. The gaming machine of claim 6 in which the device of the trigger symbol moves from its starting position across the display and when the device reaches a side of the display, a screen display changes to an initial screen display of the bonus feature.

8. The gaming machine of claim 7 in which the initial screen display of the bonus feature gives the player a choice of bonus features to be played.

9. The gaming machine of claim 1 in which the special symbol is a scatter symbol.

10. The gaming machine of any one of the preceding claims further comprising a selector for enabling the player to select one of the special symbols.

11. A method of playing a game on a game playing apparatus, the game playing apparatus comprising a display and a game controller configured to control images displayed on the display, the method comprising the steps of, if a predetermined special symbol outcome comprising a plurality of special symbols occurs in a base game, affording a player an opportunity of selecting one of those special symbols and if, as a result of that selection, a predetermined selection outcome occurs, awarding a bonus feature.

12. The method of claim 11 comprising selecting the predetermined special symbol outcome to be the occurrence of a predetermined, minimum number of the special symbols in the base game.

13. The method of claim 11 comprising selecting the predetermined selection outcome to be the occurrence of a trigger symbol.

14. The method of claim 13 comprising relating the probability of the predetermined selection outcome occurring to the number of special symbols which occurred in the base game.

15. The method of claim 13 comprising, if the predetermined selection outcome occurs, changing the selected special symbol into the trigger symbol.

16. The method of claim 15 in which the trigger symbol includes a device and a background scene.

17. The method of claim 16 comprising moving the device of the trigger symbol from its starting position across the display and when the device reaches a side of the display, changing a screen display to an initial screen display of the bonus feature.

18. The method of claim 17 comprising offering the player a choice of bonus features to be played via the initial screen display.

19. The method of claim 11 in which the special symbol is a scatter symbol.
